(19) United States
(12) Patent Application Publication
(10) Pub. No.: US 2024/0159350 A1
(43) Pub. Date: May 16, 2024

(54) Adjustable Platform Corner X-Wing Support

(71) Applicant: John Stephen Lanphear, Lawrence, MI (US)

(72) Inventor: John Stephen Lanphear, Lawrence, MI (US)

(21) Appl. No.: 18/509,991

(22) Filed: Nov. 15, 2023

Related U.S. Application Data
(60) Provisional application No. 63/425,491, filed on Nov. 15, 2022.

(51) Int. Cl. F16M 11/24; F16M 11/42

(52) U.S. Cl. CPC F16M 11/24; F16M 11/42; B66F 9/065

(57) ABSTRACT

An adjustable height platform includes three corners with lifting mechanisms and one corner without. A scissor support mechanism is located under the platform and has two pivoting ends and two sliding ends with roller bearings on each, that attach to upper and lower frames of the platform using “C” shaped bearing guides, that allow the scissor ends to roll inside each guide. In use, as the platform is raised on each corner that has a lifting actuator, the fixed scissor ends are forced to open, being pulled apart by the upper and lower frames, and thus the opposite ends of the scissor mechanism that are near the unsupported corner are forced to open and act on the upper and lower unsupported frame corner through the “C” shaped bearing guides, therefor raising the unsupported corner accordingly and proportionately to the corners with the lifting actuator. Inversely, When the top movable frame is lowered to the floor, if so equipped, the casters on this top frame come in contact with the floor before the lifting actuators are fully retracted. Therefore, the top frame cannot continue in the downward direction and the actuators begin to pull the base frame upward off of the floor and the scissor mechanism acts on the unsupported corner through the “C” shaped bearing guides to pull the unsupported base frame corner up so that the platform may be moved around easily with the assistance of the casters.

### CROSS REFERENCE TO RELATED APPLICATIONS

This application claims the benefit of U.S. Provisional Patent Application Ser. No. 63/425,491, which was filed on Nov. 15, 2023, and is titled “Adjustable Platform Corner X-Wing Support”. The entire content of this application is incorporated by reference.

### FIELD OF THE INVENTION

This application is directed to the field of height adjustable operator platforms.

### BACKGROUND OF THE INVENTION

Height adjustable operator platforms have employed various mechanisms to provide for raising and lowering of an operator or other items located on a top surface of the platform. Such mechanisms typically include linear actuators, hydraulic cylinders, and scissor mechanisms, to name a few. Some prior art platforms employ linear actuators that raise and lower a top frame. The top frame slides up and down on a bottom frame. The frames are connected using vertical steel tubing extending upward from the lower frame inside larger steel tubing attached on each corner of the upper frame. See for example, U.S. Pat. No. 6,343,556 incorporated herein by reference. The top frame often supports products or people. In most prior art arrangements, a linear actuator is located in each corner of the platform.

Consumers still desire an adjustable height platform, with an upper support surface, that is relatively square in shape, but now desire no actuator in a loading corner where their product or an operator would be located. This poses a problem for supporting the loading corner, because prior designs required an actuator in each corner to provide the necessary support. Regardless, there exists a need in the art for an adjustable height platform that is relatively square in shape but is missing and actuator from one corner and can still provide sufficient support to all four corners of the upper support surface.

### SUMMARY OF THE INVENTION

The subject invention is directed to an adjustable height platform with a movable top frame and a base frame that is relatively square in shape but has only three supporting actuators or is missing an actuator from at least one corner and can still provide sufficient support to all four corners of the movable top frame. A scissor support mechanism attaches underneath the movable top frame and connects to an unsupported corner of the upper frame. The scissor mechanism has two fixed ends. The fixed ends are located close to a corner located opposite the unsupported corner. One fixed scissor end is attached to the movable top frame near a lifting actuator. The other fixed scissor end is attached to the lower frame near the bottom of the same lifting actuator. The opposite ends of the scissor mechanism have roller bearings on each that attach to the upper and lower frames using “C” shaped bearing guides, that allow the scissor ends to roll inside each guide.

In use, as the movable top frame of the platform is raised at each corner that has a lifting actuator, the fixed scissor ends are forced to open, being pulled apart by the top movable frame and the base frame. The ends of the scissor mechanism that are near the unsupported corner are forced to open and act on the top movable frame and the base frame at the unsupported corner through the “C” shaped bearing guides. This motion raises the unsupported corner accordingly and proportionately to the corners supported with the lifting actuators. When the platform is lowered, the same principle applies in reverse.

The scissor mechanism is able to lift the unsupported corner because the “C” shaped bearing guides each have a top flange that captures a respective bearing on two ends of the scissor mechanism, allowing the mechanism to pull the bottom and top frame together. This feature is also useful when the top movable frame has casters positioned underneath. When the top movable frame is lowered to the floor, the casters come in contact with the floor before the lifting actuators are fully retracted. Therefore, the top frame cannot continue in the downward direction and the actuators begin to pull the base frame upward off of the floor so that the platform may be moved around easily with the assistance of the casters. When the top movable frame is lifted, the base frame engages the floor and the casters are lifted, thus providing the platform with a stable base frame. Preferably, the base frame includes feet that engage with the floor as the casters are lifted to provide even more stability.

Additional objects, features and advantages of the invention will become more readily apparent from the following detailed description of preferred embodiments of the invention when taken in conjunction with the drawings wherein like reference numerals refer to corresponding parts in the different views.

### BRIEF DESCRIPTION OF THE DRAWINGS

FIG. 1 is a perspective view of a height-adjustable platform, constructed in accordance with the present invention, with the platform located at a first height.

FIG. 2 is a top view of the a height-adjustable platform, of FIG. 1 including a base frame and an upper frame.

FIG. 3 is a back view of the height-adjustable platform, of FIG. 1.

FIG. 4 is a side view of the height-adjustable platform, of FIG. 1 at the first height showing a scissor lift mechanism.

FIG. 5 is close up view of a section of a first corner of the height-adjustable platform showing a sliding and pivoting end of the scissor lift mechanism.

FIG. 6 is close up view of a section of a second corner of the height-adjustable platform showing pivoting end of the scissor lift mechanism, which cannot slide relative to the base frame.

FIG. 7 is a side view of the height-adjustable platform, of FIG. 1 at the first height showing a scissor lift mechanism at a second height.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show particular details. Therefore, specific structural and functional details disclosed herein are not to be interpreted as limiting, but merely as a representative basis for teaching one skilled in the art to employ the present invention.

As used in this specification and the appended claims, the singular forms “a”, “an” and “the” include plural referents unless the content clearly dictates otherwise. As used in this specification and the appended claims, the term “or” is generally employed in its sense including “and/or” unless the content clearly dictates otherwise.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “front,” “back,” “top” and “bottom”, as well as derivatives thereof (e.g., “horizontally,” “downwardly,” “upwardly,” etc.), should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

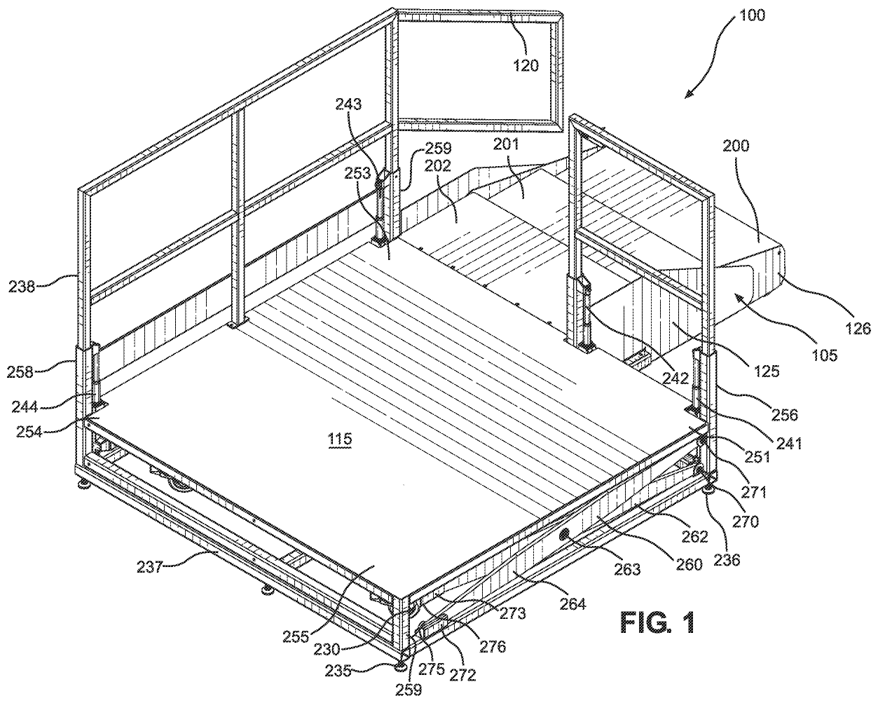

With initial reference to FIG. 1, there is illustrated a height-adjustable platform 100 constructed in accordance with the present invention. Although the present invention will be described hereinafter in the context of an adjustable height platform for supporting an operator, it will be appreciated that the invention is equally applicable to load bearing structures of many different types used in a variety of different applications. For example, height-adjustable platform can be used in office environments, restaurants or, for example, as a portable inspection station in a factory environment.

Height-adjustable platform 100 includes an adjustable staircase 105, a generally planar support surface 115, a railing 120 and platform guards 125, 126. As the height of platform 100 is adjusted, staircase 105 automatically adjusts its height and the spacing of its stairs to match, as will be described below.

Support surface 115 has four sides and provides an area for a user of platform 100 to stand while working on an adjacent assembly line or piece of machinery (not shown), and railing 120 prevents the user from accidentally falling off platform 100 in the opposite direction. Railing 120 is provided on two sides of the platform 100 which are opposite an unsupported corner described in more detail below. Platform guards 125, 126 eliminate pinch points to protect the operator during adjustment of platform 100. Staircase 105, support surface 115, railing 120 and platform guard 125 are interconnected so that these structures are simultaneously shifted relative to a surface on which platform 100 is supported.

Adjustable staircase 105 includes at least two steps, although the upper of the two steps can be level with the upper platform or surface to which the staircase is coupled. In the embodiment shown, staircase 105 includes three steps: a lower step 200, an intermediate step 201 and an upper step 202. While upper step 202 is not shown as being integral with support surface 115, such an area is to be considered an upper step within the meaning of the present disclosure. Although staircase 105 is described in connection with platform 100, an adjustable staircase, in accordance with the invention, can be used without such a platform (i.e., the staircase can be used independently). For example, an adjustable staircase can be used at a construction site to span the vertical distance between two surfaces prior to a fixed staircase being installed. Preferably, platform 100 also includes caster, two of which are labeled 230 and 231, and includes feet, two of which are labeled 235 and 236, for supporting platform 100 on a surface not shown.

Adjustable height platform 100 includes a base frame 237 and a movable top or slider frame 238. The platform 100 and more particularly the support surface 115 is relatively square in shape, but would not be limited to such, as best seen in FIG. 1, and preferably is formed with as a planar support surface. The adjustable height platform 100 is provided with a group of lifting mechanisms in the form of supporting actuators 241, 242, 243, 244 which are provided between the base frame 237 and the movable top frame 238. Preferably as shown, the supporting actuators 241, 242, 243, 244 are a set of electric motors. The motors may be the LA31 series of motors produced by Linak Corporation as shown. The actuators preferably use screw drives, although other types of linear actuators or motors can also be used (e.g., hydraulic, pneumatic). Typically, such motors are available in four different load capacities which are 1,500 newtons, 2,000 newtons, 4,000 newtons and 6,000 newtons. Ideally the load capacity would be matched with a final users' desires depending on what type of load or usage the platform 100 will be used for. More details regarding a vertically adjustable table are found in U.S. Pat. No. 6,874,432 incorporated herein by reference.

Preferably three of the supporting actuators 241, 243, and 244 are located at three respective corners 251, 253, and 254 of the support surface 115. Another corner of the support surface 115, unsupported corner 255, is unsupported by any actuators. The movable top frame 238 constitutes a slider frame assembly having four outer tubes 256, 257, 258 and 259.

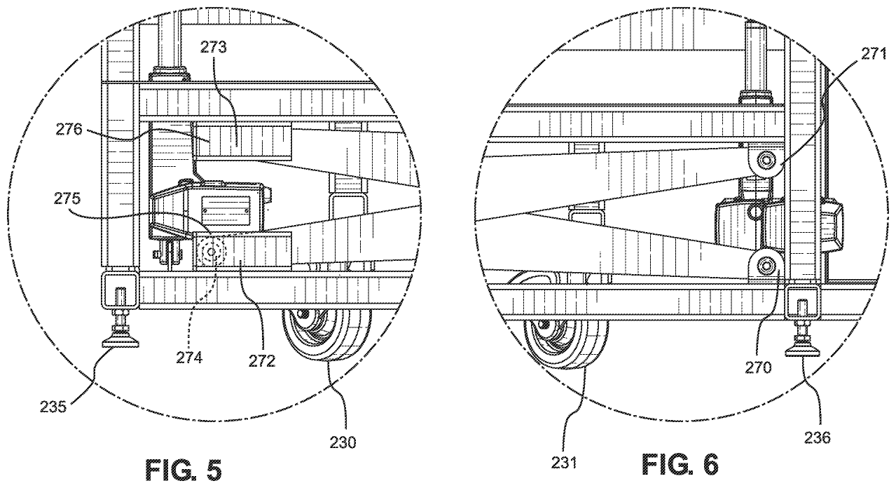

A scissor support mechanism 260 and a second scissor support mechanism 261 attach underneath the movable top frame 238. The scissor support mechanism 260 connects to the unsupported corner 255 of the movable top frame 238. The scissor mechanism 260 has a first beam 262 with a pivot mechanism 263 connecting to a second beam 264 connected to the first beam 162. The scissor mechanism 260 has two fixed ends 270, 271. The fixed scissor ends 270, 271 are fixed in the sense that the ends can pivot but not slide. One of the fixed ends 270 is located close to the corner 251 located opposite the unsupported corner 255 and is connected to the base frame 237. The other fixed scissor end 271 is attached to the movable top frame 238 near the lifting actuator 241. The other fixed scissor end 270 is attached to the base frame 237 by the same lifting actuator 241. The opposite ends of the scissor mechanism are sliding connections 272, 273 which have roller bearings, one marked with reference number 274. See FIG. 5. “C” shaped guides 275, 276 allow the scissor ends 272, 273 to slide inside each guide. Note that the lifting actuator 244 is not connected to the guide 275 but is located at supported corner 254 as best seen in FIG. 1.

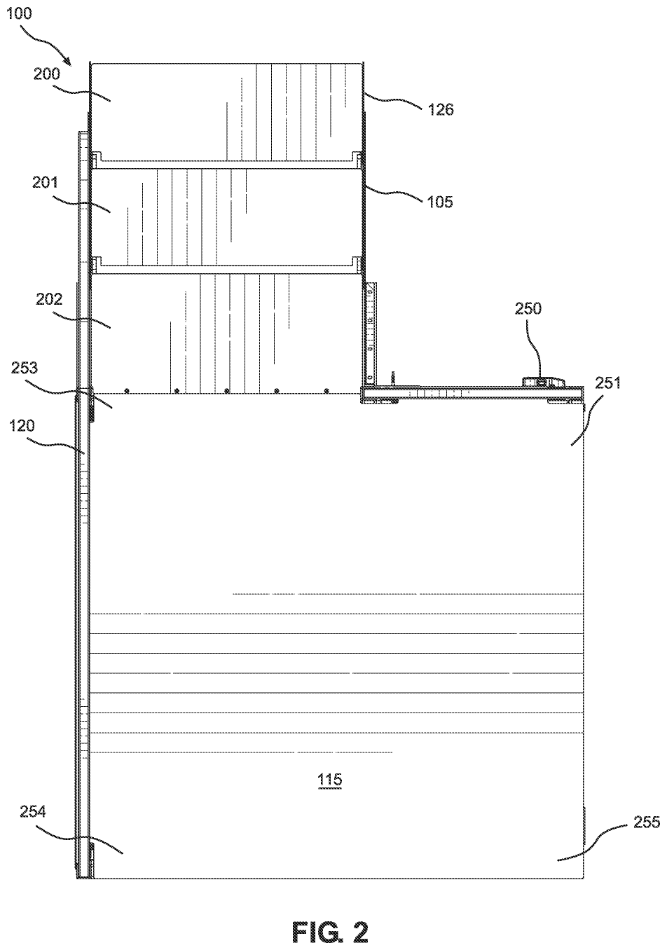

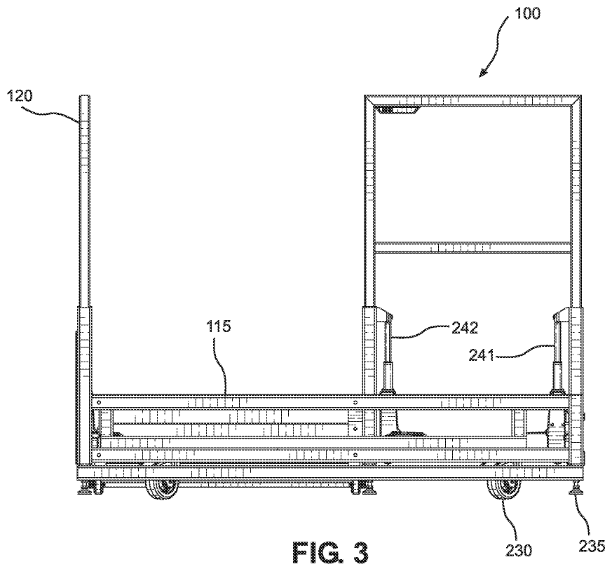

FIG. 2 shows a top view of the adjustable height platform 100 clearly showing three supported corners 251, 253 and 254 and one unsupported corner 255. FIG. 3 shows a rear view of adjustable height platform with the casters, such as caster 230 is in a lower mobile mode where the feet such as foot 235 is lifted away from the ground.

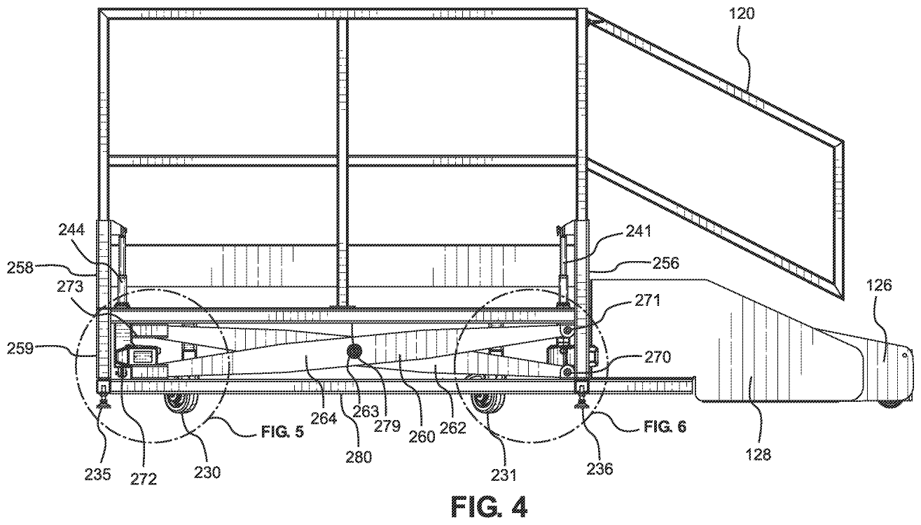

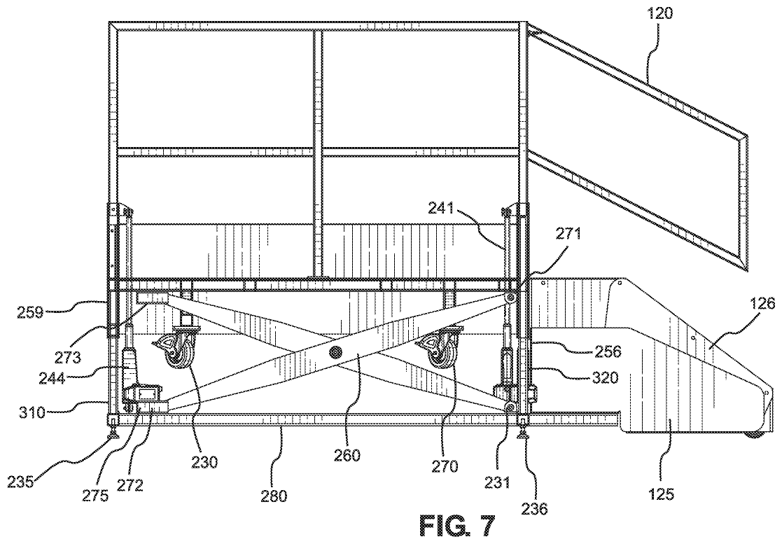

FIGS. 4-6 show a side view of the height adjustable platform 100 at a lower height and FIG. 7 shows the height adjustable platform 100 at a higher raised height with the movable top frame 238 in an upper mode. FIG. 5 is a close in view of the arrangement near caster 230. Note particularly how caster 230 is below foot 235. Also shown are the sliding connections 272 and 273 of the scissor mechanism 260. As best seen in FIG. 5, the “C” shaped bearing guide 275 has a top flange 278 that captures the bearing wheels 274 on two ends with sliding connections 272, 273 of the scissor mechanism 260, allowing the mechanism 260 to pull the base frame 237 and the movable top frame 238 together as best seen in FIGS. 4 and 5. This feature of this invention allows the scissor mechanism 260 to lift the unsupported corner 255.

This feature is also useful because the movable top frame 238 preferably has casters 230, 231 positioned underneath, which 230 and 231 casters are just two represented as examples that a platform such as this presumably would have at least four casters. When the movable top frame is lowered to a floor, not separately illustrated, the casters 230, 231 come in contact with the floor before the lifting actuators 241, 242, 243, 244 are fully retracted, and therefore the moveable top frame 238 cannot continue in the downward direction and the lifting actuators 241, 242, 243, 244 begin to pull the base frame 237 upward off of the floor so that the adjustable height platform 100 may be moved around easily with the assistance of the casters 230, 231.

In a similar manner FIG. 6 is a close in view of the arrangement near caster 231. Note particularly how caster 231 is below foot 236. Also shown are fixed pivoting connections, fixed scissor ends 270, 271. FIG. 7 shows the height adjustable platform in a mode at a higher height. Note casters 230 and 231 are raised or lifted and feet 235 and 236 are lowered to extend and be in a ground engaging mode. When moveable top frame 238 is lifted, the base frame 237 engages the floor and the casters 230, 231 are lifted, thus providing the height adjustable platform 100 with stability. Preferably, the base frame 237 includes feet 235 and 236 that engage with the floor to provide even more stability. Base frame 237 also includes four upright legs, two of which are labelled 310 and 320. Two additional legs are present in corners 253 and 254. Two of the tubes 256 and 259 slide along the legs 310, 320 as the top frame 238 slides up and down. At least one of the actuators 241, 243, and 244 is a lifting mechanism located near a one of the upright legs 320 and is attached to said base frame 237 for moving movable top frame 238 relative to said base frame 237 such that one leg 310 at the unsupported corner 255 is without a lifting mechanism. Two additional lifting mechanisms, supporting actuators 243 and 244 are located near two of the four legs not separately labelled, such that three legs are provided with a lifting mechanism. While FIGS. 1 and 7 show platform 100 at two different heights, platform 100 is selectively positionable at any number of different heights, as desired by a user.

In use, as the movable top frame 238 of the height adjustable platform 100 is raised by supporting actuators 241, 242, 243, 244, (supporting actuator 242 may not be needed as a fourth actuator in many configurations of operator platforms) two fixed ends 270, 271 of the scissor mechanism 260 are forced to open, being pulled apart by the base frame 237 and movable top frame 238, and thus slidable connections 272, 273 of the scissor mechanism 260 that are near the unsupported corner 255 are forced to open and act on the base frame 237 and movable top frame 238 and unsupported corner 255 through the “C” shaped guides 275, 276, therefor raising that unsupported corner 255 accordingly and proportionately to three supported corners 251, 253 and 254. When the adjustable height platform 100 is lowered, the same principle applies.

In any case, although described with reference to exemplary embodiments of the invention, it should still be understood that modifications can be made to the invention as disclosed without departing from the spirit of the invention.

What is claimed is:

1. A height-adjustable platform comprising:
a base frame having at least two upright legs;
a slider frame assembly slidably mounted on the at least two upright legs;
a lifting mechanism located near one leg of the at least two upright legs and attached to said base frame for moving said slider frame relative to said base frame such that one leg of the at least two upright legs is without a lifting mechanism;
a scissor mechanism having a first beam and a second beam connected to the first beam with a pivot mechanism, wherein:
the first beam has a lower end connected to the base frame by a lower sliding connection located near the leg without a lifting mechanism and a second end connected to the slider frame by an upper pivoting connection located near the leg near the lifting mechanism, and
the second beam has a lower end connected to the base frame by a lower pivoting connection located near the leg near the lifting mechanism and a second end connected to the slider frame by an upper sliding connection located near the leg without the lifting mechanism for providing support for the slider frame.

2. The height-adjustable platform of claim 1 further comprising two additional lifting mechanisms.

3. The height-adjustable platform of claim 2 further comprising a generally planar support surface having four sides with two sides including support rails.

4. The height-adjustable platform of claim 3, wherein the two sides with support rails extend between legs with lifting mechanisms.

5. The height-adjustable platform of claim 1, further comprising a second scissor mechanism.

6. The height-adjustable platform of claim 1, wherein the slider frame includes casters, and the base frame includes feet.

7. The height-adjustable platform of claim 6, wherein the platform is configured to operate in a mobile lower mode with the casters extend below the feet to allow the platform to move and a stationary upper mode where the lifting mechanisms extend to lift the casters, so the feet extend below the casters.

8. A height-adjustable platform comprising:
a base frame;
a slider frame assembly slidably mounted on the base frame;
a lifting mechanism attached to said base frame for moving said slider frame relative to said base frame; and
a scissor mechanism having a first beam and a second beam connected to the first beam with a pivot mechanism, wherein the first beam has a lower end connected to the base frame by a lower sliding connection located near a corner of the base frame without a lifting mechanism and a second end connected to the slider frame by an upper pivoting connection located near the lifting mechanism.

9. The height-adjustable platform of claim 8, wherein the second beam has a lower end connected to the base frame by a lower pivoting connection located near the lifting mechanism and a second end connected to the slider frame by an upper sliding connection for providing support for the slider frame.

10. A height-adjustable platform comprising:
a base frame;
a slider frame assembly slidably mounted on the base frame;
a lifting mechanism attached to said base frame for moving said slider frame relative to said base frame; and a scissor mechanism having a first beam and a second beam connected to the first beam with a pivot mechanism, wherein the first beam has a lower end connected to the base frame by a lower sliding connection located near a corner of the base frame without a lifting mechanism and a second end connected to the slider frame by an upper pivoting connection located near the lifting mechanism; and wherein the second beam has a lower end connected to the base frame by a lower pivoting connection located near the lifting mechanism and a second end connected to the slider frame by an upper sliding connection for providing support for the slider frame.

11. The height adjustable platform of claim 10 that wherein the scissor mechanism also acts on the unsupported corner to lift the lower frame up when the lifting mechanism is lowered.

12. A method of operating a height-adjustable platform including a base frame having upright legs and feet; a slider frame assembly slidably mounted on the upright legs and having casters; a lifting mechanism located near one of the upright legs and attached to said base frame for moving said slider frame relative to said base frame such that one leg is without a lifting mechanism; a scissor mechanism having a first beam and a second beam connected to the first beam with a pivot mechanism, wherein the first beam has a lower end connected to the base frame by a lower sliding connection located near the leg without a lifting mechanism and a second end connected to the slider frame by an upper pivoting connection located near the leg with a lifting mechanism, and the second beam has a lower end connected to the base frame by a lower pivoting connection located near the leg with a lifting mechanism and a second end connected to the slider frame by an upper sliding connection located near the leg without the lifting mechanism for providing support for the slider frame and generally planer support surface, said method comprising:
lowering the slider frame relative to the base frame with the lifting mechanisms and extending the casters below the feet to allow the platform to move; and
raising the slider frame relative to the base frame with the lifting mechanisms and retracting the casters above the feet to fix the platform in place.
